(19) United States
(12) Patent Application Publication
(10) Pub. No.: US 2004/0246513 A1
(43) Pub. Date: Dec. 9, 2004

(54) Method and apparatus for crash recovery on an image forming apparatus

(75) Inventors: Brian E. McKinley, Boise, ID (US); David L. Smith, Eagle, ID (US); James Clough, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD COMPANY

(21) Appl. No.: 10/452,044

(22) Filed: Jun. 3, 2003

(51) Int. Cl. B41F 1/00

(52) U.S. Cl. 358/1.14

(57) ABSTRACT

A method and apparatus for crash recovery on an image forming apparatus is provided including steps of spooling an imaging job, tracking an imaging status of the imaging job, and deleting the imaging job upon re-initialization of the imaging forming apparatus if the imaging status of the imaging job is a predetermined imaging status.

### BACKGROUND OF THE INVENTION

Printers for imaging print jobs on a paper media are known. To print an item in a typical configuration, a user operating a computer selects a “print” option on an application running on the computer, such as a word processing program. The computer then generates a print job from the word processing program, and transmits the print job to a spooler located on the computer. The spooler schedules print jobs for each printer accessible to the computer. After the print job has been successfully spooled for a given printer, the print job is transmitted to the printer for printing.

Problems exist, however, when an error occurs during the printing process. By way of example, errors may occur which cause the printer to freeze up or hang. In such an instance, a user may re-initialize the printer (e.g., by turning the printer off-and-on, by pressing a reset button, etc.), whereupon the printer may remain frozen or hung in some instances.

### BRIEF DESCRIPTION OF THE DRAWINGS

FIG. 1 depicts a computer and an image forming apparatus according to an embodiment of the present invention.

FIG. 2 depicts a method of performing crash recovery on an image forming apparatus according to an embodiment of the present invention.

FIG. 3 depicts a method of printing an image on a printer according to an embodiment of the present invention.

FIG. 4 depicts additional steps for performing crash recovery added to the method of FIG. 3, according to an embodiment of the present invention.

### DETAILED DESCRIPTION OF THE EMBODIMENTS

The following description will be provided in reference to an image forming device 120. It should be appreciated that the phrase “image forming device” is intended to encompass devices capable of imaging an item on a media, such as laser printers, ink jet printers, photocopiers, facsimile machines, etc. Other image forming devices are also within the scope of this invention, as would be readily apparent to one of ordinary skill in the art after reading this disclosure.

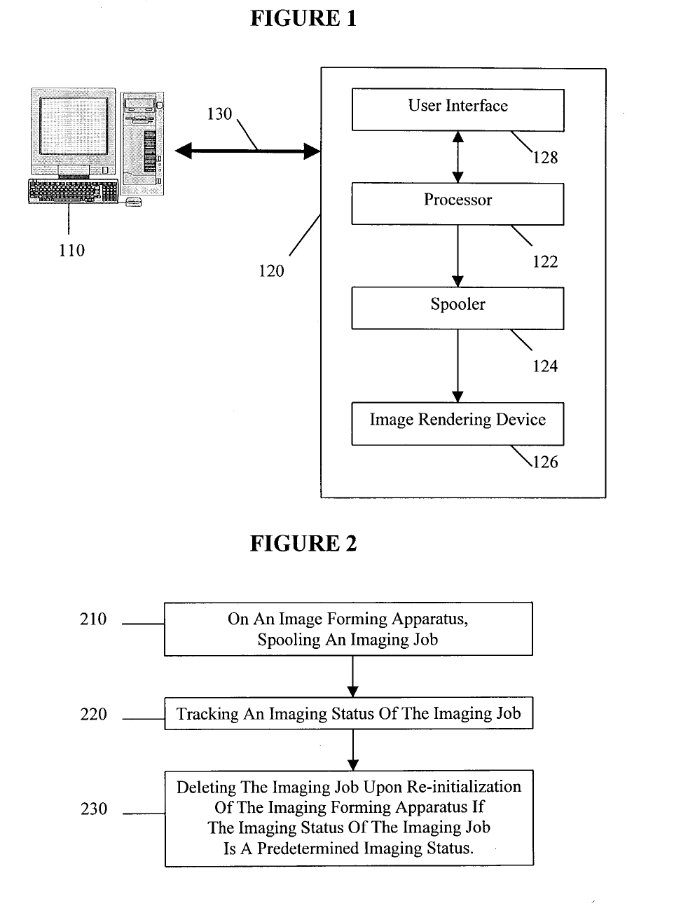

An exemplary computer 110 and imaging forming device 120, according to an embodiment of the present invention, are shown in the block diagram of FIG. 1. The computer 110 may comprise a stand-alone computer (e.g., a desktop or notebook), a network server coupled to a plurality of stand-alone computers, etc. As shown, the computer 110 is electrically coupled to the image forming device 120 via link 130. Link 130 may comprise, for example, a network link, a cable, etc. Alternatively, the computer 110 and image forming device 120 may be integrated in a single device, such as a palmtop computer or digital camera with built-in printer.

In operation, the computer 110 generates imaging jobs that are sent to the image forming device 120 via link 130. By way of example, a user operating the computer 110 may select a print option on an application running on the computer 110, such as a word processing program. The computer then generates a print job (i.e., one type of imaging job), and transmits it to the image forming device 120. Hence, a print driver on the computer 110 may accept data from the application, and convert the data to a Page Description Language (PDL), such as Postscript or PCL.

The exemplary image forming device 120 includes a processor 122, a spooler 124, and an image rendering device 126. While the processor 122, spooler 124, and image rendering device 126 are shown as discrete components, they may be merged in whole or in part, such as the processor 122 forming part of spooler 124 and/or image rendering device 126. Similarly, the spooler 124 may be represented by the processor 122 performing a spooling function for the image rendering device 126. The processor 122, spooler 124, and image rendering device 126 are shown as discrete components for purposes of illustration only.

The processor 122 is programmed to receive the print job from the computer 110. As such, the processor 122 may store the print job in a memory (not shown) upon receipt from the computer 110. The “stored” print job is then sent to spooler 124, which schedules the print job for rendering by the image rendering device 126. By way of example, spooler 124 may schedule the image rendering data in a queue of imaging jobs to be imaged by the image rendering device 126. The processor 122 may be further programmed to rasterize stored print job, such as converting the print job into an inking format that the image rendering device 126 understands.

The spooler 124 transmits print jobs to the image rendering device 126 based on the spooler queue. By way of example, the image rendering device 126 may comprise a laser printing mechanism, an ink jet printing mechanism, etc., whereby the image rendering device 126 renders print jobs transmitted thereto by the spooler 124.

The image forming device 120 described above is thus fully capable of rendering images for a plurality of imaging jobs. In normal operation, the image forming device 120 continues to receive new print jobs from computer 110, and images them on a media stock based on the spooler queue. However, if an error occurs (e.g., on the image forming device 120 or link 130), the processor 122 is programmed to take appropriate action. By way of example, a power surge may cause the image forming device 120 to freeze up or hang, or the imaging device 120 may receive a print job in a format that it does not “understand”, but tries to process anyway (e.g. a job is sent in Postscript but the image forming device 120 only understands PCL). In many instances, the imaging device 120 also hangs due to the processor 122 attempting to execute an offending or corrupted command as part of processing a given print job (e.g., attempting to access an invalid memory location, running out of virtual memory, etc.). The frozen/hung image forming device 120 thus stops imaging the print jobs until the error is cleared.

To clear the error and unfreeze/unhang the imaging device 120, a user may re-initialize the image forming device 120, thereby returning the image forming device 120 to an online condition. By way of example, the user may turn the image forming device 120 off and then back on again, press a reset button on the user interface 128, or take some other appropriate action.

Upon re-initialization, the processor 122 is programmed to delete print jobs having a predetermined imaging status. By way of example, the processor 122 may delete all print jobs that have not yet cleared out of the spooler 124, all print jobs currently being spooled by spooler 124, and/or all print jobs currently being imaged by image rendering device 126 (“currently” referring to a process taking place simultaneously with the error occurrence).

According to one embodiment of the present invention, the processor 122 is programmed to query a user upon re-initialization of the image rendering device 120 as to whether or not to retry a given imaging job prior to deletion. By way of example, the processor 122 may notify the user via the user interface 128 (e.g., a touch screen display or the like), and retry a given imaging job if the user enters “retry job” (i.e., one type of positive query) on the user interface 128. Similarly, the processor 122 may delete the imaging job if the user fails to give a positive query or if the user fails to make any entry at all (e.g., examples of negative user queries).

According to another embodiment of the present invention, the processor 122 may be programmed to automatically retry imaging jobs having a pre-determined imaging status upon re-initialization. By way of example, the processor 122 may retry imaging jobs having a “spooled” status a predetermined number of times (e.g., one retry) by default, then delete the imaging job if the imaging rendering device 126 fails to render the image.

In this manner, an effective technique for reducing or eliminating image forming device 120 hang-ups upon re-initialization can be achieved. Unlike prior art systems where the spooler is on a computer separate from the image forming apparatus, the spooler 124 of the present invention may be part of the image forming apparatus 120 itself, because repeated freezing/hang-ups can be eliminated upon re-initialization thereof.

A method of crash recovery for an image forming apparatus according to yet another embodiment of the present invention is shown in the flowchart of FIG. 2. According to this embodiment, on the image forming apparatus 120, an imaging job is spooled in step 210. By way of example, an imaging job stored on the image forming apparatus 120 may be transmitted to a spooler 124 on the image forming apparatus 120 for spooling the imaging job thereon.

In step 220, the image forming apparatus 120 tracks an imaging status of the imaging job, such as “completed” imaging job, “spooled” imaging job, “printing” imaging job, etc. By way of example, the image forming apparatus may maintain an attribute table including a descriptor of the imaging status of the imaging job. Alternatively, the image forming apparatus may manipulate a file name of stored imaging jobs so as to include a descriptor of the imaging status of the imaging jobs. See commonly assigned, co-pending application, entitled “Method Of Tracking A File Processing Status With A File Name”, by Brian McKinley, filed the same day as the present application, which is incorporated by reference herein in its entirety.

When an error occurs, the image forming apparatus is re-initialized in a like manner as previously described (e.g., by a user turning the image forming apparatus off-and-on, pressing a reset button, etc.). Upon re-initialization, the image forming apparatus then deletes imaging jobs having a predetermined imaging status in step 230. By way of example, the image forming apparatus may delete, in step 230, imaging jobs that were completed, spooled, or imaging when the error occurred. In this manner, an effective technique for reducing or eliminating hang ups upon re-initialization can be achieved.

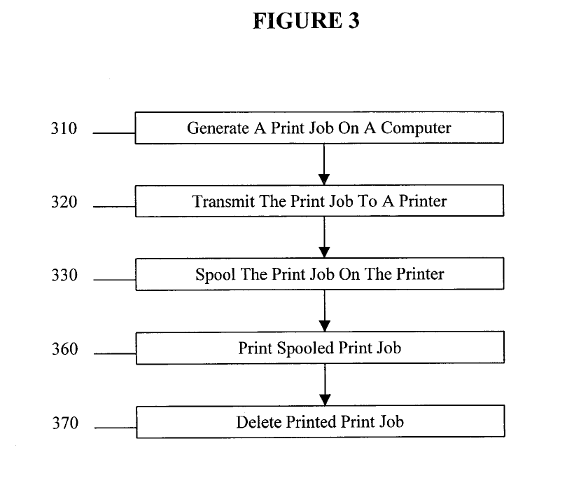

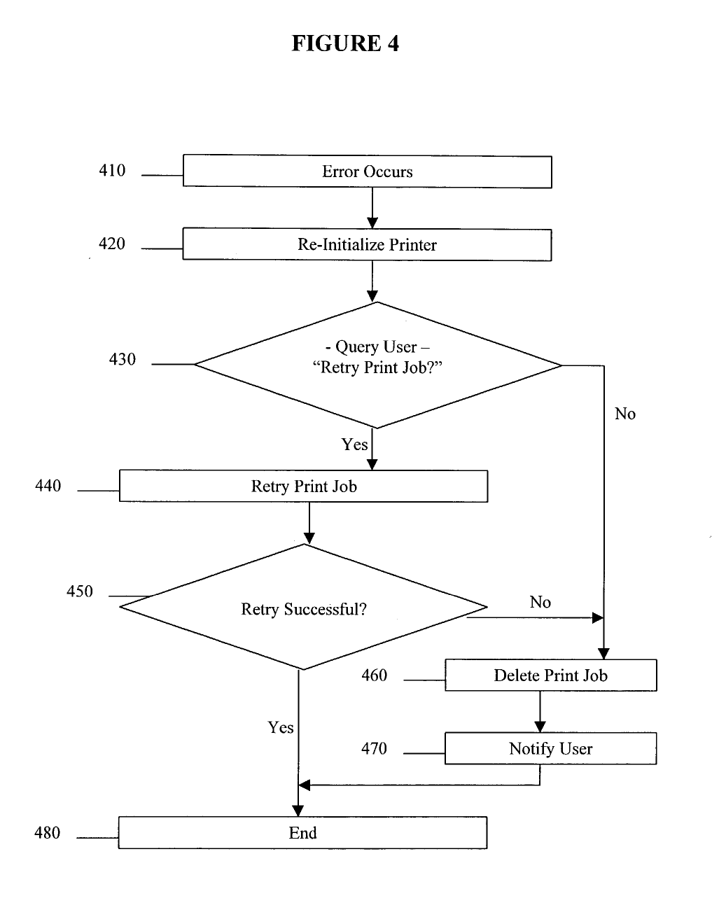

A method of crash recovery for a printer according to yet another embodiment of the present invention is shown in the flowcharts of FIGS. 3 and 4. Normal operation of a printer is shown in FIG. 3, with a crash recovery operation shown in FIG. 4. More specifically, referring to FIG. 3, in step 310, a computer generates a print job in a like manner as previously described. The print job is then transmitted to the printer in step 320, and optionally stored thereon. It should be appreciated that multiple print jobs from several different computers may be generated in step 310, transmitted in step 320, and stored while the printer is printing a given print job or in a standby mode. Hence, it is not necessary for a print job to be completed before a new print job can be received by the printer. As part of step 320, the printer may manipulate a file name of a received print job to indicate a “received” printing status of the print job.

In step 330, the printer spools the print job in a queue of print jobs. By way of example, the queue may include a large number of print jobs received from various computers to be printed by the printer. As part of step 330, the printer may manipulate the file name of the print job to indicate a “spooled” printing status of the print job.

The printer then prints spooled print jobs in the queued order in step 360, and updates the file name to indicate a “printing” printing status of the print job. Upon completion thereof, the printer then deletes the print job from memory and/or the spooler in step 370, and/or may update the file name to indicate a “completed” printing status of the print job if it is retained in memory or in an attribute table.

Printer operation when an error occurs is shown in FIG. 4. Error step 410 may occur at any point in the method shown in FIG. 3. An “error” generally refers to any problem that may cause the printer to hang or freeze, thereby preventing the printer from printing the print job. Exemplary errors include those noted above with respect to FIG. 1.

When an error has occurred in step 410, the printer is re-initialized in step 420 in a like manner, as previously described. The printer then queries the user in step 430 whether or not to re-try the print job. By way of example, the printer may display a message “Re-try Print Job” on a touch screen display, flash a light on “Re-try Print Job” button, etc. Alternatively, the printer may automatically re-try the print job based on the printing status.

If the user selects “Re-try Print Job”, the printer then re-tries the print job in step 440. By way of example, the printer may re-initiate step 360 in FIG. 3. If the printer is successful in re-trying the print job in step 450, the printer then ends in step 480. According to one embodiment of the present invention, the printer defaults to a “re-try once”, where a frozen print job is retried upon a first initialization, and marked for deletion if the printer is unsuccessful in retrying the print job.

If the printer is unsuccessful in re-trying the print job in step 450 or if the user does not select “Re-try Print Job” in step 430, the printer deletes print jobs having a predetermined printing status in step 460. Hence, the printer may delete all print jobs that are spooled, printing, completed, or previously re-tried, as these print jobs have the highest likelihood of causing the printer to freeze/hang. The printer then notifies the user of the deletion in step 470 (e.g., via user interface 128), and ends in step 480. By way of example, the printer may display a message on the user interface 128 (e.g., “print job deleted”), flash a light on the printer indicating a print job has been deleted, email a notification message to a computer issuing the print job if the printer is network accessible, etc.

In this manner, a printer including effective crash recovery programming can be implemented. The printer can take appropriate action to clear a spooler integrated thereon, such that the printer is not frozen/hung on re-initialization when an error has occurred.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A method of crash recovery for an image forming apparatus, comprising:
on the image forming apparatus, spooling an imaging job;
tracking an imaging status of the imaging job; and
deleting the imaging job upon re-initialization of the imaging forming apparatus if the imaging status of the imaging job is a predetermined imaging status.

2. The method of claim 1, wherein the predetermined imaging status comprises a completed imaging job.

3. The method of claim 1, wherein the predetermined imaging status comprises a spooled imaging job.

4. The method of claim 1, wherein the predetermined imaging status comprises a printing imaging job.

5. The method of claim 1, wherein re-initialization comprises turning on the image forming apparatus.

6. The method of claim 1, wherein re-initialization comprises returning the image forming apparatus to an online condition.

7. The method of claim 1, further comprising:
retrying the imaging job upon re-initialization of the image forming apparatus,
wherein deleting the imaging job deletes imaging jobs which were not successfully retried.

8. The method of claim 1, further comprising:
querying a user upon re-initialization of the image forming apparatus whether to retry the imaging job; and
retrying the imaging job if the user query is positive,
wherein deleting the imaging job deletes the imaging job if the user query is negative.

9. The method of claim 1, further comprising:
notifying a user when an imaging job has been deleted.

10. The method of claim 1, wherein tracking the imaging status of the imaging job comprises:
maintaining an attribute table on the image forming apparatus including a descriptor of the imaging status of the imaging job.

11. The method of claim 1, further comprising:
storing the imaging job on the image forming apparatus.

12. The method of claim 11, wherein tracking the imaging status of the imaging job comprises:
manipulating a file name of the stored imaging job so as to include a descriptor of the imaging status of the imaging job.

13. The method of claim 1, wherein the image forming apparatus comprises one of a photocopier, a printer, and a facsimile machine.

14. An image forming apparatus, comprising:
an image rendering device;
a spooler configured to spool imaging jobs for the image rendering device; and
a processor programmed to delete imaging jobs upon re-initialization of the imaging forming apparatus if an imaging status of the imaging job is a predetermined imaging status.

15. The image forming apparatus of claim 14, wherein the predetermined imaging status comprises a completed imaging job.

16. The image forming apparatus of claim 14, wherein the predetermined imaging status comprises a spooled imaging job.

17. The image forming apparatus of claim 14, wherein the predetermined imaging status comprises a printing imaging job.

18. The image forming apparatus of claim 14, wherein re-initialization comprises turning on the image forming apparatus.

19. The image forming apparatus of claim 14, wherein re-initialization comprises returning the image forming apparatus to an online condition.

20. The image forming apparatus of claim 14, further comprising a user interface, wherein the processor is further programmed to:
query a user via the user interface upon re-initialization of the image forming apparatus whether to retry the imaging job; and
retry the imaging job if the user query is positive,
wherein the processor is programmed to delete imaging jobs if the user query is negative.

21. The image forming apparatus of claim 14, wherein the processor is further programmed to maintain an attribute table on the image forming apparatus including a descriptor of the imaging status of the imaging jobs.

22. The image forming apparatus of claim 14, further comprising a memory, wherein the processor is further programmed to:
store the imaging jobs in the memory.

23. The image forming apparatus of claim 22, wherein the processor is further programmed to manipulate a file name of the imaging jobs so as to include a descriptor of the imaging status of the imaging jobs.

24. The image forming apparatus of claim 14, wherein the image forming apparatus comprises one of a photocopier, a printer, and a facsimile machine.

25. A program product comprising machine readable program code for causing a printer to perform method steps of:
spooling a print job on the printer;
tracking a printing status of the print job; and
delete the print job upon re-initialization of the printer if the printing status of the print job is a predetermined printing status.

26. The program product of claim 25, wherein the predetermined printing status comprises one of a spooled print job, a printing print job, and a completed print job.

27. The program product of claim 25, further comprising machine readable program code for causing the printer to delete completed print jobs upon completion.

28. The program product of claim 25, further comprising machine readable program code for causing the printer to:
receive print jobs from a computer.

29. The program product of claim 25, wherein re-initialization comprises one of turning on the printer and returning the printer to an online condition.

30. An imaging device, comprising:
means for spooling an image job;
means for imaging spooled imaging jobs; and
means for deleting imaging jobs having a predetermined imaging status upon re-initialization of the imaging device.
